(19) United States
(12) Patent Application Publication
(10) Pub. No.: US 2004/0146344 A1
(43) Pub. Date: Jul. 29, 2004

(54) Stepped locating diameter for a press fit component

(76) Inventor: Anthony T. D'Amico, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/352,422

(22) Filed: Jan. 28, 2003

(51) Int. Cl. F16D 1/00

(52) U.S. Cl. 403/345; 29/525

(57) ABSTRACT

A seal assembly includes an outer diameter and a locating diameter. The locating diameter is a stepped down diameter from the seal outer diameter which is press fit into the bore. The locating diameter is of a diameter which provides a clearance fit in a bore and extends for an axial length to provide a relatively stable prepositioning of the seal assembly in the bore. In a method of assembly, the locating diameter of the seal assembly is initially placed into the bore and a flat surface is utilized to press the seal assembly fully into the bore.

### BACKGROUND OF THE INVENTION

The present invention relates to press fit components, and more particularly to a press fit seal component having a locating feature and a method of installation thereof.

Various housings include a bore to receive a press fit member such as a seal. The seal provides a rotational interface between the housing and a rotating shaft such as common to a differential carrier assembly for an axle assembly. Proper installation of press fit components may often be a relatively complex procedure which requires expensive tooling and fixtures, high press forces, and tight tolerances.

A press fit seal utilizes an interference fit between the seal diameter and a housing bore diameter. The seal outer diameter is typically press fit into the bore diameter with a tool to provide alignment of the seal with the bore. Even a slight misalignment of the seal to the bore may result in an unacceptable misalignment. Some seals have a rubber outer diameter which may be even more easily damaged from an initial misalignment.

Relatively complex and expensive tooling is utilized to press fit the seal into the bore which is often chamfered in an attempt to initiate the seating of the seal. Even though the tooling indexes in a number of locations on the housing and the seal, misalignment may still occur due to the strict tolerance requirements. Minor misalignment is overcome by the force of the press which may yield the seal outer diameter such that the seal is press fit in a cocked orientation. Such minor misalignment may be initially difficult to detect through conventional quality control procedures. However, even a relatively small misalignment may result in a failed seal. Furthermore, the minor misalignment may still go unnoticed and be misdiagnosed as a shaft to bore misalignment problem resulting in costly overhaul, repair and/or replacement of relatively expensive components.

In addition to assuring proper alignment, press fit seal components must also provide a fluid tight barrier. Even when properly aligned, conventional seals often require a resilient gasket material coating to seal the seal outer diameter into the housing. Such a resilient material is often incompatible with press fitting as the resilient gasket material may be stripped from the seal outer diameter during the press fitting operations. A properly aligned seal may therefore still be subject to leakage.

Eventually, even if initially properly installed and sealed, the press fit component may need to be replaced in a field environment. Such replacement is quite difficult to achieve in a field environment in which relatively large and complex tooling available in a manufacturing setting is unavailable.

Accordingly, it is desirable to provide a press fit component and a method of installation thereof which assures alignment of the press fit component and which is replaceable in a relatively austere field environment.

### SUMMARY OF THE INVENTION

The seal assembly of the present invention includes an outer diameter and a locating diameter. The locating diameter is a stepped down diameter from the seal outer diameter which is press fit into a bore. The locating diameter is of a diameter which provides a clearance fit in the bore and extends for an axial length to provide a relatively stable propositioning of the seal assembly in the bore of a housing.

In a method of assembly according to the present invention, the locating diameter of the seal assembly is initially placed into the bore. The seal assembly rests upon the stepped surface and is thereby prepositioned for a pressing operation. Complex alignment and indexing tooling is therefore effectively eliminated.

A flat surface such as a mandrel which extends from a press is then utilized to press the seal assembly into the bore. As the locating diameter provides alignment, only a relatively simple press is required. Moreover, the axial length of the locating diameter tends to index the seal assembly perpendicular to the bore even if the seal assembly is initially not exactly perpendicular thereto. Such a response is particularly advantageous in a field repair environment.

The present invention therefore provides a press fit component and a method of installation thereof which assures alignment of the press fit component and which is replaceable in a relatively austere field environment.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general sectional view of a differential carrier assembly for use with the present invention;

FIG. 2 is an expanded sectional view of a press fit seal assembly;

FIG. 3A is an exploded partial sectional view of the seal assembly adjacent a bore having a geometry according to the present invention;

FIG. 3B is an exploded partial sectional view of the seal assembly adjacent a bore having a geometry according to the present invention;

FIG. 4 is the seal assembly initially placed into a locating bore prior to a pressing operation according to the present invention; and

FIG. 5 is the seal assembly pressed into place after a pressing operation according to the present invention; and

### DETAILED DESCRIPTION OF THE PREFERRED EMBODIMENT

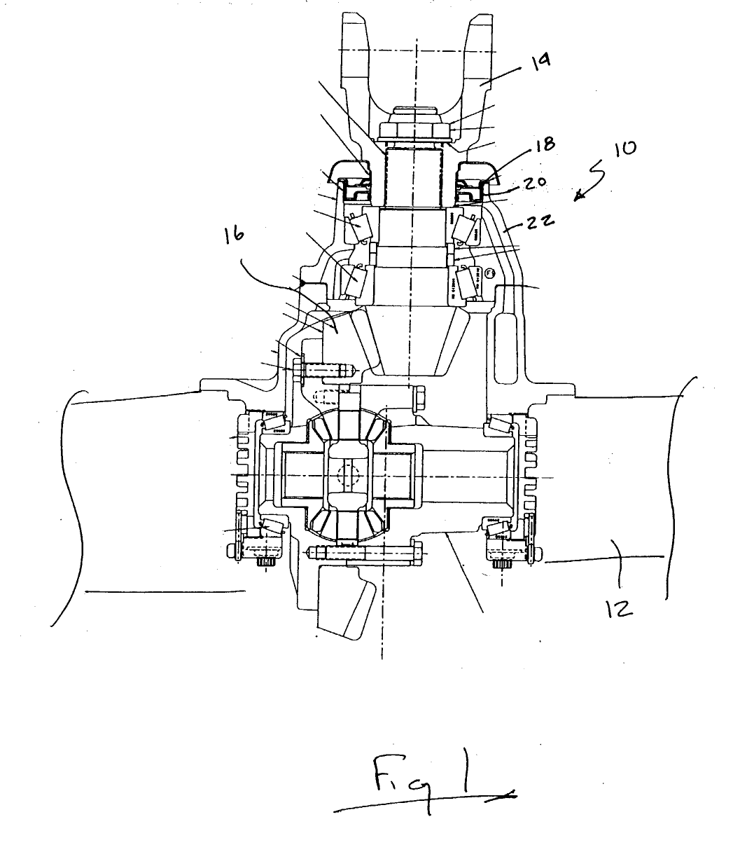

FIG. 1 illustrates a general sectional view of a differential carrier assembly 10 for an axle assembly 12 or the like. The carrier assembly 10 receives an input through an input yoke 14 which then drives the axle assembly 12 through a gear train 16 or the like. The yoke 14 rotates within a seal assembly 18 which is pressed into a bore 20 defined by a housing 22. It should be understood that although a press fit seal assembly is disclosed in the illustrated embodiment, various press fit components such as coverjoints, circular joints with a male and female component, bearing assemblies will also benefit from the present invention.

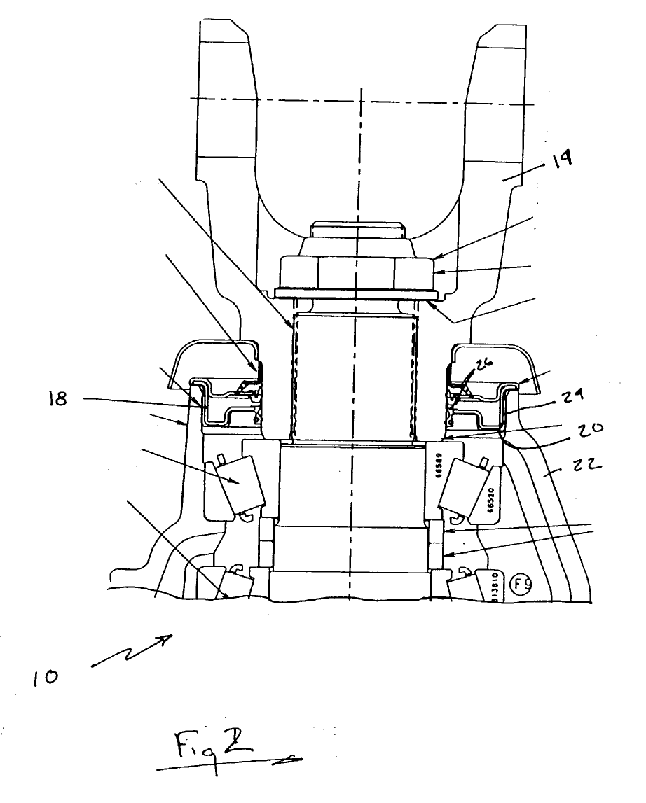

Referring to FIG. 2, the seal assembly 18 defines a seal outer diameter 24 which is press fit into the bore 20. Press fit as defined herein refers to an interference fit. The seal assembly 18 is preferably formed as a formed sheet metal component that supports one or more resilient seals 26 to seal the rotating input yoke 14 to prevent the escape of oil from within the differential carrier assembly 10 and the ingestion of debris into the carrier assembly 10.

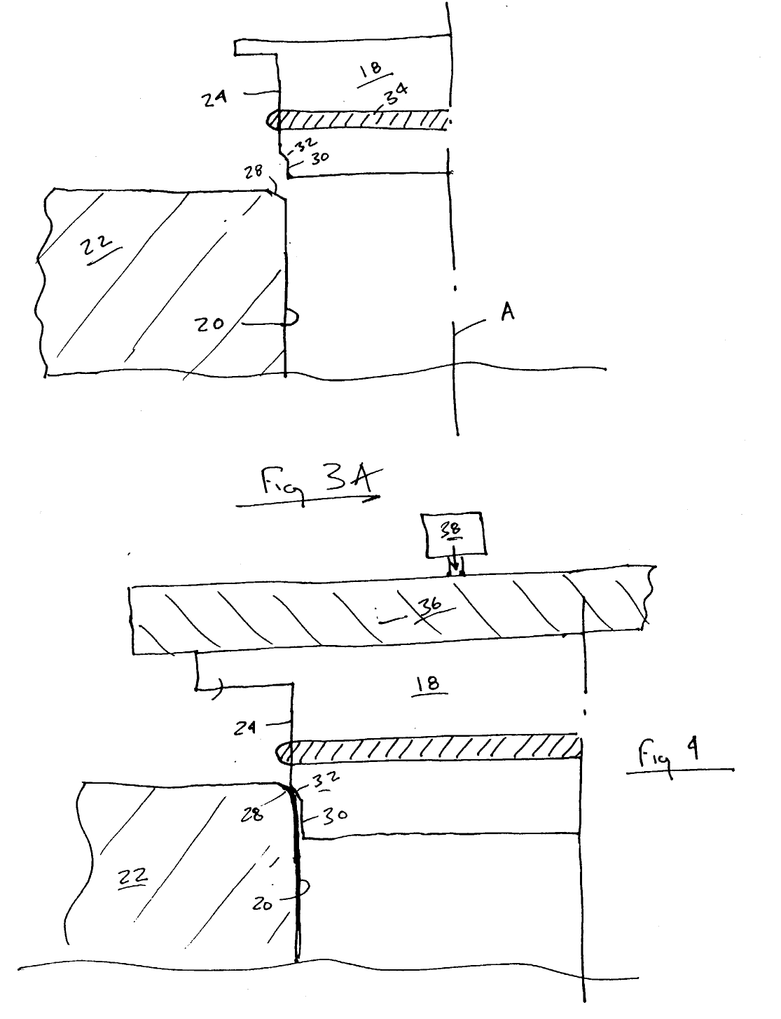

Referring to FIG. 3A, the bore 20 is defined about an axis A. The bore 20 is of a diameter which provides an interference fit for receipt of the seal outer diameter 24. A chamfer 28 is preferably located along the top of the bore 20 in which the seal assembly is inserted. The chamfer 28 assists in locating the seal assembly 18 into the bore 20. It should be understood that the term “chamfer” as used herein includes radiuses and any broken edge.

The seal assembly 18 includes a locating diameter 30. The locating diameter 30 is a stepped down diameter from the seal outer diameter 24 which is press fit into the bore 20. That is, a stepped surface 32 is formed between the seal outer diameter 24 and the locating diameter 30. The locating diameter 30 is of a diameter which provides a clearance fit in the bore 20. That is, the locating diameter 30 is just small enough to fit within the bore 20 when in a tolerance stack up condition. Preferably, the locating diameter 30 also includes a chamfer/radius 33 on the edge which is inserted into the bore 20.

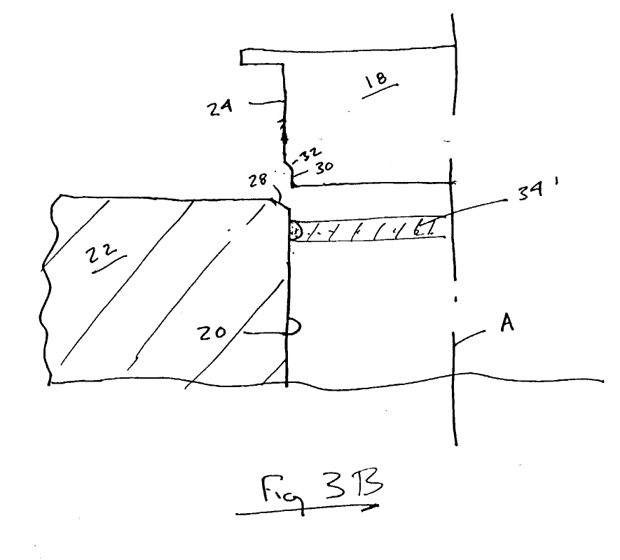

The locating diameter 30 extends for an axial length to provide an index to insert the locating diameter 30 into the bore 20. That is, the axial distance of the locating diameter 30 allows a relatively stable prepositioning of the seal assembly 18 in the bore 20 prior to final pressing of the seal assembly 18 into place (FIG. 4).

A gasket material 34 is located about the seal outer diameter 24. Preferably, a flow on gasket material or other liquid gasket material such as LOCTITE 518® is beaded along the seal outer diameter 24. The gasket material 34 may alternatively or additionally be located about the locating diameter 30 (FIG. 3B). Preferably, a flow on gasket material or other liquid gasket material such as LOCTITE 518® is beaded along the inner wall of the locating diameter 30.

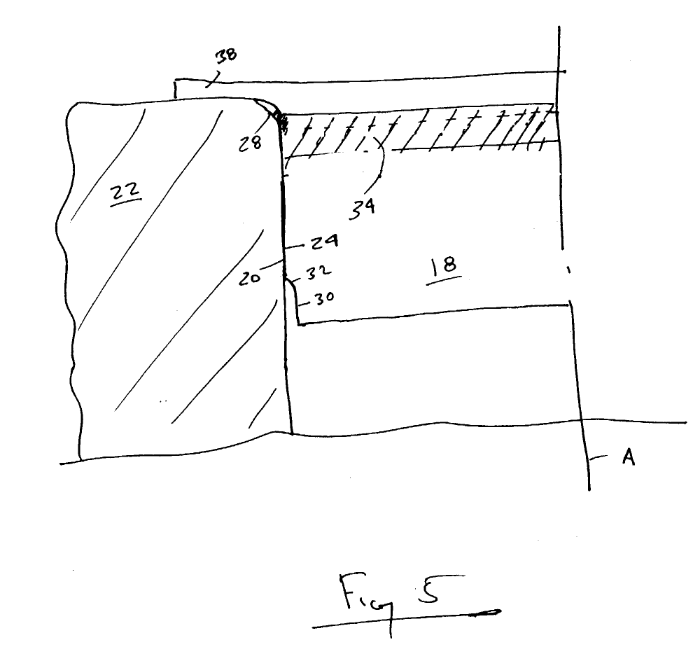

Referring to FIG. 4, the locating diameter 30 of the seal assembly 18 is initially placed into the bore 20. The locating diameter 30 is preferably manually located into the bore 20. That is, the seal assembly 18 is simply dropped into place by hand. The seal assembly 18 rests upon the stepped surface 32 and is thereby prepositioned for a pressing operation (FIG. 5). It should be understood that the clearance between the locating diameter 30 and bore 20 is exaggerated for the sake of clarity. The seal assembly 18 is automatically aligned with the bore 20 by the placement of the locating diameter 30 into the bore 20. Complex alignment and indexing tooling is therefore effectively eliminated.

A flat surface 36 such as a mandrel which extends from a press (illustrated schematically at 38) is then utilized to press the seal assembly 18 into the bore 20. As the locating diameter 30 provides alignment, only a relatively simple press is required. Moreover, the axial length of the locating diameter 30 tends to index the seal assembly 18 perpendicular to the bore 20 even if the seal assembly 18 is initially not exactly perpendicular thereto. That is, the locating diameter 30 tends to correct misalignment when the seal assembly 18 is pressed by the flat surface 36 in comparison to a conventional tool which tends to hold and press the seal crooked if the seal is initially misaligned. Such a response is particularly advantageous in a field repair environment.

Referring to FIG. 5, the seal assembly 18 has been press fit into the bore 20. A radial flange 38 provides depth control of the pressing operation. The flange 38 also provides a reception area for the gasket material 34 adjacent the chamfer 28 once the seal assembly 18 is press fit into the bore 20.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A method of press fitting a press fit component having a press fit component outer diameter and a locating diameter within a bore having a bore inner diameter smaller than the press fit component outer diameter, said method comprising the steps of:
(1) locating a locating diameter of a press fit component within a bore inner diameter larger than the press fit component locating diameter; and
(2) pressing the press fit component outer diameter into the bore inner diameter to provide an interference fit between the press fit component outer diameter and the bore inner diameter.

2. A method as recited in claim 1, further comprising the step of:
applying a gasket material to the press fit component outer diameter prior to said step (1).

3. A method as recited in claim 1, further comprising the step of:
applying a gasket material to the press fit component bore inner diameter as a bead prior to said step (1).

4. A method as recited in claim 1, wherein said step (1) further comprises manually locating the press fit component locating diameter within the bore.

5. A method as recited in claim 1, wherein said step (2) comprises pressing the press fit component with a flat interface.

6. A press fit assembly comprising:
a press fit component defining a press fit component outer diameter and a press fit component locating diameter, said press fit component locating diameter smaller than said press fit component outer diameter; and
a housing defining a bore having a bore inner diameter smaller than said press fit component outer diameter and larger than said press fit component locating diameter.

7. The press fit assembly as recited in claim 6, wherein said press fit component locating diameter is substantially concentric to said press fit component outer diameter.

8. The press fit assembly as recited in claim 6, further comprising a stepped surface between said press fit component locating diameter and said press fit component outer diameter.

9. The press fit assembly as recited in claim 8, wherein said stepped surface sits upon said bore inner diameter prior to a press operation.

10. The press fit assembly as recited in claim 6, further comprising a gasket material extending from said press fit component outer diameter.

11. The press fit assembly as recited in claim 6, wherein said press fit component comprises an oil seal.

12. The press fit assembly as recited in claim 6, wherein said press fit component locating diameter and said press fit component outer diameter comprises a sealing material.

13. The press fit assembly as recited in claim 6, wherein said press fit component comprises a bearing.
